(19) United States
(12) Patent Application Publication
(10) Pub. No.: US 2025/0087987 A1
(43) Pub. Date: Mar. 13, 2025

(54) TIMER-BASED FAULT PROTECTION CIRCUIT

(71) Applicant: MICRO MOTION, INC., Boulder, CO (US)

(72) Inventor: Ashish Shrikant BANDIWADEKAR, Pradhikaran Nigdi, Pune (IN)

(73) Assignee: MICRO MOTION, INC., Boulder, CO (US)

(21) Appl. No.: 18/727,242

(22) PCT Filed: Jan. 24, 2022
(86) PCT No.: PCT/US2022/013537

§ 371 Date: Jul. 8, 2024

(51) Int. Cl. H02H 3/02; H02H 9/04

(52) U.S. Cl. CPC H02H 3/025; H02H 9/04

(57) ABSTRACT

A timer-based fault protection circuit (100) is provided, which comprises a high voltage line (102) configured to electrically couple to a first terminal of an intrinsically safe load (ISL), a low voltage line (104) configured to electrically couple to a second terminal of the intrinsically safe load (ISL), a voltage limiter (110) and a delay/LIP enable circuit (120) electrically coupled to the high voltage line (102) and the low voltage line (104) electrically parallel to the intrinsically safe load (ISL), and a switchable low impedance path (130) electrically coupled to the high voltage line (102) and the low voltage line (104) in a shunt configuration relative to the intrinsically safe load (ISL). The voltage limiter (110) is communicatively coupled to the delay/LIP enable circuit (120) and configured to provide a signal to the delay/LIP enable circuit (120) and the delay/LIP enable circuit (120) is communicatively coupled to the switchable low impedance path (130) and configured to provide a signal to the switchable low impedance path (130).

### TECHNICAL FIELD

The embodiments described below relate to fault protection circuits and, more particularly, to a timer-based fault protection circuit.

### BACKGROUND

Some processing systems require more power to run its intended functionality in an intrinsically safe (IS) zone. This high-power requirement may be due to a high-speed multicore processor with inbuilt FPGA, for example. The high-power requirement may, in some cases, only be fulfilled by supplying high current. However, worst case fault condition should be considered during designing of an IS barrier because barrier operation comes into picture only in fault condition.

During normal operating conditions, these barriers may need to be open circuit and not a part in regular circuit operation. Conventional Zener barriers may not be suitable for such high current/power application because of high power dissipation during fault condition. Under the fault in high power dissipation condition, Zener lead and its case temperature can easily cross the maximum threshold level and can damage the barrier. If the IS barrier is damaged, then an IS load may be exposed to a fault condition.

Conventional Zener diode barriers have been employed but may require an undesirably large form factor (e.g., board space, overhead space, heat dissipation hardware, etc.) to be effective in high current applications. In addition, the Zener diodes may require an undesirably high-power dissipation and therefore significant heat dissipation requirement. Smaller form factors without such undesirably high-power dissipation requirements can be used if the time-period of the Zener diodes is limited. Accordingly, there is a need for a timer-based fault protection circuit.

### SUMMARY

A timer-based fault protection circuit is provided. According to an embodiment, the timer-based fault protection circuit comprises a high voltage line configured to electrically couple to a first terminal of an intrinsically safe load, a low voltage line configured to electrically couple to a second terminal of the intrinsically safe load, a voltage limiter and a delay/LIP enable circuit electrically coupled to the high voltage line and the low voltage line electrically parallel to the intrinsically safe load, and a switchable low impedance path electrically coupled to the high voltage line and the low voltage line in a shunt configuration relative to the intrinsically safe load. The voltage limiter is communicatively coupled to the delay/LIP enable circuit and configured to provide a signal to the delay/LIP enable circuit and the delay/LIP enable circuit is communicatively coupled to the switchable low impedance path and configured to provide a signal to the switchable low impedance path.

A method of forming a timer-based fault protection circuit is provided. According to an embodiment, the method comprises configuring a high voltage line to electrically couple to a first terminal of an intrinsically safe load, configuring a low voltage line to electrically couple to a second terminal of the intrinsically safe load, electrically coupling a voltage limiter and a delay/LIP enable circuit to the high voltage line and the low voltage line electrically parallel to the intrinsically safe load, electrically coupling a switchable low impedance path to the high voltage line and the low voltage line in a shunt configuration relative to the intrinsically safe load, communicatively coupling the voltage limiter to the delay/LIP enable circuit and configured to provide a signal to the delay/LIP enable circuit, communicatively coupling the delay/LIP enable circuit to the switchable low impedance path, and configuring the delay/LIP enable circuit to provide a signal to the switchable low impedance path.

### ASPECTS

According to an aspect, a timer-based fault protection circuit comprises a high voltage line configured to electrically couple to a first terminal of an intrinsically safe load, a low voltage line configured to electrically couple to a second terminal of the intrinsically safe load, a voltage limiter and a delay/LIP enable circuit electrically coupled to the high voltage line and the low voltage line electrically parallel to the intrinsically safe load, and a switchable low impedance path electrically coupled to the high voltage line and the low voltage line in a shunt configuration relative to the intrinsically safe load. The voltage limiter is communicatively coupled to the delay/LIP enable circuit and configured to provide a signal to the delay/LIP enable circuit and the delay/LIP enable circuit is communicatively coupled to the switchable low impedance path and configured to provide a signal to the switchable low impedance path.

Preferably, the timer-based fault protection circuit further comprises a transient voltage suppression diode having a first terminal electrically coupled to the high voltage line and a second terminal electrically coupled to the low voltage line, wherein the transient voltage suppression diode is configured to conduct a current between the high voltage line and the low voltage line when a voltage of the high voltage line is greater than a breakdown voltage of the transient voltage suppression diode.

Preferably, when the signal is received from the delay/LIP enable circuit, the switchable low impedance path is configured to conduct a forward conduction current between the high voltage line and the low voltage line at a voltage that is less than a breakdown voltage of the transient voltage suppression diode.

Preferably, the voltage limiter is configured to sense a voltage of the high voltage line relative to a voltage of the low voltage line and provide the signal to the delay/LIP enable circuit when the voltage of the high voltage line relative to the voltage of the low voltage line is greater than an over-voltage threshold value.

Preferably, the voltage limiter comprises a voltage divider having a first terminal electrically coupled to the high voltage line and a second terminal electrically coupled to the low voltage line and configured to provide a reference voltage based on the voltage of the high voltage line relative to the voltage of the low voltage line and a first voltage adjustable shunt regulator having a first terminal electrically coupled to the high voltage line, a second terminal electrically coupled to the low voltage line, and a voltage reference terminal configured to receive the reference voltage, wherein the first voltage adjustable shunt regulator is configured to conduct a current based on the reference voltage.

Preferably, the delay/LIP enable circuit is configured to receive the signal from the voltage limiter, initiate a timer function of the delay/LIP enable circuit when the signal is received from the voltage limiter, and provide the signal to the switchable low impedance path when the timer function reaches a delay threshold value.

Preferably, the delay/LIP enable circuit comprises an RC network configured to receive the signal from the voltage limiter and charge one or more capacitors in the RC network to a voltage using the signal from the voltage limiter, a second voltage adjustable shunt regulator electrically coupled to the RC network and configured to receive the voltage of the one or more capacitors in the RC network and conduct a current based on the voltage of the one or more capacitors of the RC network, and an SCR enable switch electrically coupled to the second voltage adjustable shunt regulator, the SCR enable switch being configured to provide the signal to the switchable low impedance path when the second voltage adjustable shunt regulator conducts the current.

Preferably, the second voltage adjustable shunt regulator comprises a first terminal electrically coupled to the high voltage line and a base terminal of the SCR enable switch, a second terminal electrically coupled to the low voltage line, and a reference voltage terminal configured to receive the voltage of the one or more capacitors of the RC network. The second voltage adjustable shunt regulator is configured to conduct the current from the high voltage line to the low voltage line in proportion to the voltage of the one or more capacitors of the RC network.

Preferably, the switchable low impedance path comprises an SCR having a first terminal electrically coupled to the high voltage line, a second terminal electrically coupled to the low voltage line, and a gate electrically coupled to the SCR enable switch so as to receive the signal from the delay/LIP enable circuit. The SCR is configured to conduct a forward conduction current between the high voltage line and the low voltage line when the signal from the delay/LIP enable circuit exceeds a gate threshold value.

Preferably, the signal received from the delay/LIP enable circuit comprises a voltage value of the high voltage line that exceeds the gate threshold value.

Preferably, the SCR is configured to conduct the forward conduction current while a forward conduction current is greater than a holding current of the SCR.

According to an aspect, a method of forming a timer-based fault protection circuit comprises configuring a high voltage line to electrically couple to a first terminal of an intrinsically safe load, configuring a low voltage line to electrically couple to a second terminal of the intrinsically safe load, electrically coupling a voltage limiter and a delay/LIP enable circuit to the high voltage line and the low voltage line electrically parallel to the intrinsically safe load, electrically coupling a switchable low impedance path to the high voltage line and the low voltage line in a shunt configuration relative to the intrinsically safe load, communicatively coupling the voltage limiter to the delay/LIP enable circuit and configured to provide a signal to the delay/LIP enable circuit, communicatively coupling the delay/LIP enable circuit to the switchable low impedance path, and configuring the delay/LIP enable circuit to provide a signal to the switchable low impedance path.

Preferably, the method further comprises electrically coupling a first terminal of a transient voltage suppression diode to the high voltage line and a second terminal to the low voltage line, wherein the transient voltage suppression diode is configured to conduct a current between the high voltage line and the low voltage line when a voltage of the high voltage line is greater than a breakdown voltage of the transient voltage suppression diode.

Preferably, when the signal is received from the delay/LIP enable circuit, configuring the switchable low impedance path to conduct a forward conduction current between the high voltage line and the low voltage line at a voltage that is less than a breakdown voltage of the transient voltage suppression diode.

Preferably, the method further comprises configuring the voltage limiter to sense a voltage of the high voltage line relative to a voltage of the low voltage line and provide the signal to the delay/LIP enable circuit when the voltage of the high voltage line relative to the voltage of the low voltage line is greater than an over-voltage threshold value.

Preferably, electrically coupling the voltage limiter to the high voltage line and the low voltage line comprises electrically coupling a first terminal of a voltage divider to the high voltage line and a second terminal of the voltage divider to the low voltage line and configuring the voltage divider to provide a reference voltage based on the voltage of the high voltage line relative to the voltage of the low voltage line and electrically coupling a first terminal of a first voltage adjustable shunt regulator to the high voltage line and a second terminal of the first voltage adjustable shunt regulator to the low voltage line, receiving with a voltage reference terminal of the first voltage adjustable shunt regulator the reference voltage, and configuring the first voltage adjustable shunt regulator to conduct a current based on the reference voltage.

Preferably, the method further comprises configuring the delay/LIP enable circuit to receive the signal from the voltage limiter, initiate a timer function of the delay/LIP enable circuit when the signal is received from the voltage limiter, and provide the signal to the switchable low impedance path when the timer function reaches a delay threshold value.

Preferably, the delay/LIP enable circuit comprises an RC network configured to receive the signal from the voltage limiter and charge one or more capacitors in the RC network to a voltage using the signal from the voltage limiter, a second voltage adjustable shunt regulator electrically coupled to the RC network and configured to receive the voltage of the one or more capacitors in the RC network and conduct a current based on the voltage of the one or more capacitors of the RC network, and an SCR enable switch electrically coupled to the second voltage adjustable shunt regulator, the SCR enable switch being configured to provide the signal to the switchable low impedance path when the second voltage adjustable shunt regulator conducts the current.

Preferably, the second voltage adjustable shunt regulator comprises a first terminal electrically coupled to the high voltage line and a base terminal of the SCR enable switch, a second terminal electrically coupled to the low voltage line, and a reference voltage terminal configured to receive the voltage of the one or more capacitors of the RC network. The second voltage adjustable shunt regulator is configured to conduct the current from the high voltage line to the low voltage line in proportion to the voltage of the one or more capacitors of the RC network.

Preferably, the switchable low impedance path comprises an SCR having a first terminal electrically coupled to the high voltage line, a second terminal electrically coupled to the low voltage line, and a gate electrically coupled to the SCR enable switch so as to receive the signal from the delay/LIP enable circuit. The SCR is configured to conduct a forward conduction current between the high voltage line and the low voltage line when the signal from the delay/LIP enable circuit exceeds a gate threshold value.

Preferably, the signal received from the delay/LIP enable circuit comprises a voltage value of the high voltage line that exceeds the gate threshold value.

Preferably, the SCR is configured to conduct the forward conduction current while the forward conduction current is greater than a holding current of the SCR.

### BRIEF DESCRIPTION OF THE DRAWINGS

The same reference number represents the same element on all drawings. It should be understood that the drawings are not necessarily to scale.

FIG. 1 shows a timer-based fault protection circuit 100.

FIG. 2 shows a more detailed view of the timer-based fault protection circuit 100 described with reference to FIG. 1.

FIG. 3 shows an alternative timer-based fault protection circuit 300.

FIG. 4 shows a timing diagram 400 illustrating a timing of a timer-based fault protection circuit, such as the timer-based fault protection circuits 100, 300 discussed above with reference to FIGS. 1-3.

FIG. 5 shows a method 500 of forming a timer-based fault protection circuit.

### DETAILED DESCRIPTION

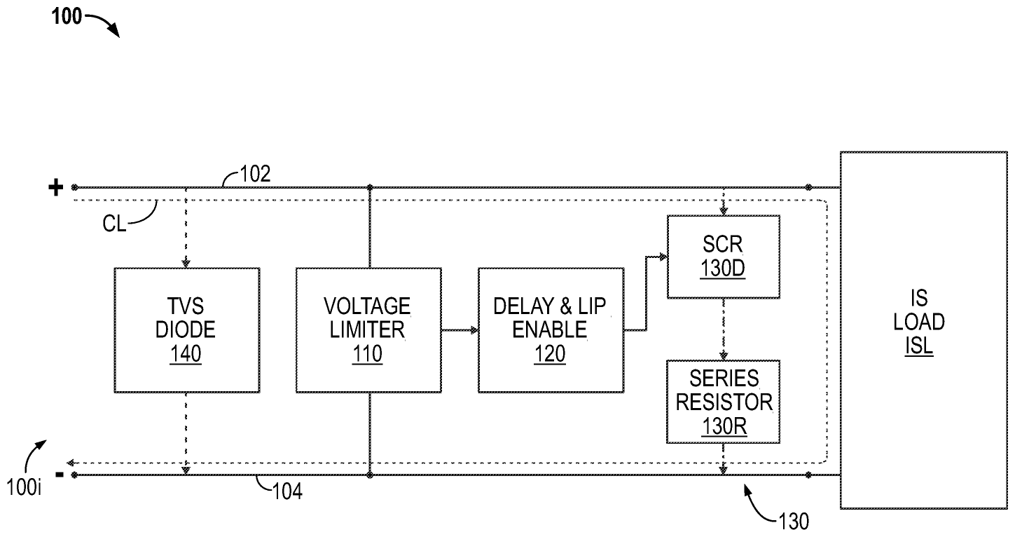

FIGS. 1-5 and the following description depict specific examples to teach those skilled in the art how to make and use the best mode of embodiments of a timer-based fault protection circuit. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the time-based fault protection circuit. As a result, the embodiments described below are not limited to the specific examples described below, but only by the claims and their equivalents.

FIG. 1 shows a timer-based fault protection circuit 100. As shown in FIG. 1, the timer-based fault protection circuit 100 includes an input 100i that is communicatively coupled to a high voltage line 102 and a low voltage line 104. The high voltage line 102 and the low voltage line 104 are electrically coupled to an intrinsically safe load ISL. More specifically, the high voltage line 102 is electrically coupled to a first terminal of the intrinsically safe load ISL and the low voltage line 104 is electrically coupled to a second terminal of the intrinsically safe load ISL. The high voltage line 102, the low voltage line 104, and the intrinsically safe load ISL form a current loop CL, which is illustrated by a dashed line with an arrow at one end indicating a direction of a current in the current loop CL. As shown in FIG. 1, the high voltage line 102 and the low voltage line 104 are comprised only of a conductor and therefore may be referred to as a high voltage terminal. Alternative high voltage lines may include elements, such as lumped elements. For example, an alternative high voltage line and/or low voltage line may include resistive, capacitive, and/or inductive elements.

Also shown in FIG. 1 is a voltage limiter 110 electrically coupled to the high voltage line 102 and the low voltage line 104 parallel to the input terminals. As shown in FIG. 1, the voltage limiter 110 includes a first terminal that is electrically coupled to the high voltage line 102 and a second terminal that is electrically coupled to the low voltage line 104. A delay/low impedance path (“LIP”) enable circuit 120 is also electrically coupled to the high voltage line 102 and the low voltage line 104 parallel to the input terminals. For example, as shown in FIG. 1, the delay and LIP enable circuit 120 includes a first terminal that is electrically coupled to the high voltage line 102 and a second terminal that is electrically coupled to the low voltage line 104. As shown in FIG. 1, the voltage limiter 110 is shown as being electrically coupled to the delay/LIP enable circuit 120. For example, as shown in FIG. 1, the voltage limiter 110 is communicatively coupled to the delay/LIP enable circuit 120 in a direction that is shown by an arrow.

Also shown in FIG. 1 is a switchable low impedance path 130 that is electrically coupled to the high voltage line 102 and the low voltage line 104. The switchable low impedance path 130 is shown as including a first terminal that is electrically coupled to the high voltage line 102 and a second terminal that is electrically coupled to the low voltage line 104. The switchable low impedance path 130 includes a SCR 130D and a series resistor 130R. As used herein, the acronym “SCR” may refer to a silicon-controlled rectifier, although alternative devices may be employed even if not referred to as a silicon-controlled rectifier. For example, thyristors may be employed in the switchable low impedance path 130.

The SCR 130D and the series resistor 130R are electrically coupled in series. More specifically, a first terminal of the SCR 130D is electrically coupled to the high voltage line 102 and a second terminal of the SCR 130D is electrically coupled to a first terminal of the series resistor 130R. A second terminal of the series resistor 130R is electrically coupled to the low voltage line 104. Accordingly, the second terminal of the SCR 130D is electrically coupled to the low voltage line 104 via the series resistor 130R, although the SCR 130D may be directly electrically coupled to the low voltage line 104. The SCR 130D and/or the series resistor 130R may be selected to ensure that a desirably low power dissipation level is achieved, although any suitable criteria may be employed.

FIG. 1 also shows a transient voltage shunt (“TVS”) diode 140 that is electrically coupled to the high voltage line 102 and the low voltage line 104 in parallel with the input terminals. More specifically, a first terminal of the TVS diode 140 is electrically coupled to the high voltage line 102 and a second terminal of the TVS diode 140 is electrically coupled to the low voltage line 104. The TVS diode 140 may be any one or more diodes that may be reversed bias so as to conduct when a threshold voltage, such as a breakdown voltage, of the diode is exceeded.

When the input 100i is subjected to a normal voltage condition, there is no current flow through the TVS diode 140, voltage limiter 110, and the switchable low impedance path 130. That is, a current only flows from the positive terminal through the high voltage line 102, through the intrinsic safety load ISL, and to the negative terminal via the low voltage line 104. This current flow is shown in FIG. 1 as the current loop CL.

When the input 100i is subjected to an overvoltage condition, such as, for example, a transient overvoltage condition, the TVS diode 140 is configured to clamp a voltage difference between the high voltage line 102 and the low voltage line 104 to a voltage clamp value Vclamp. Substantially simultaneously, the voltage limiter 110 is also configured to detect the overvoltage condition of the input 100i and provide a signal to the delay/LIP enable circuit 120 to begin a timer function.

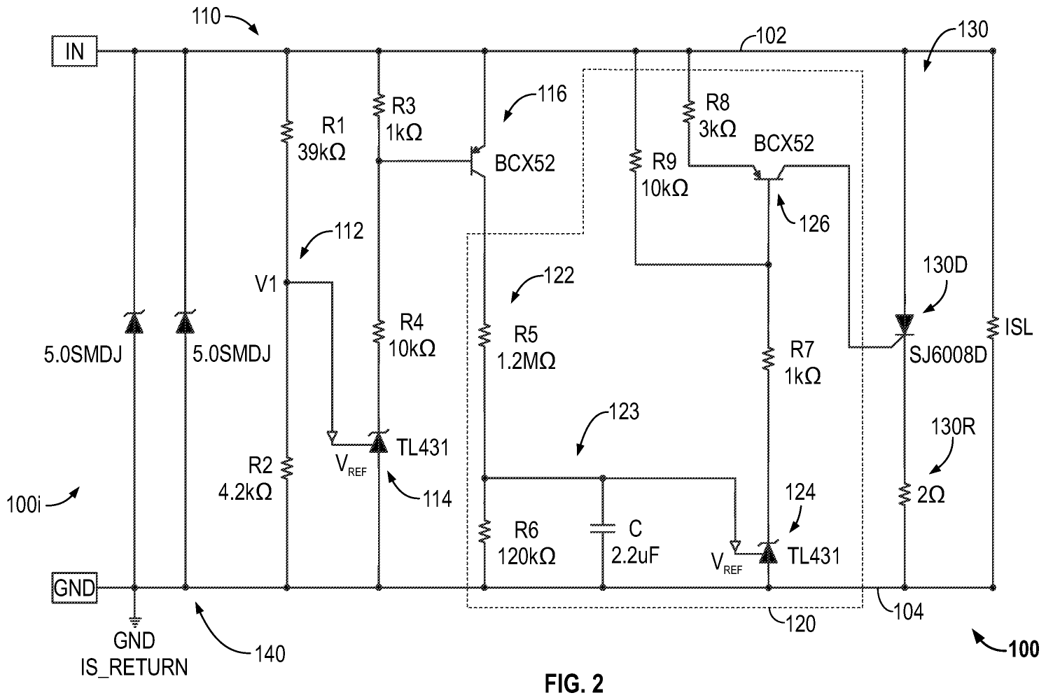

For example, the voltage limiter 110 may cause the delay/LIP enable circuit 120 to be subjected to a voltage, an example of which will be described in more detail in the following with reference to FIG. 2. While subjected to the voltage condition, the delay/LIP enable circuit 120 may perform the timer function that determines if the voltage has been applied for a time-period, which may be a predetermined delay time-period. After the delay/LIP enable circuit 120 is subjected to the voltage for the time-period, the delay/LIP enable circuit 120 enables the switchable low impedance path 130 to conduct current between the high voltage line 102 and the low voltage line 104.

The delay/LIP enable circuit 120 may be subjected to the voltage due to the overvoltage condition of the input 100i. More specifically, the voltage limiter 110 may be configured to subject the delay/LIP enable circuit 120 to the voltage while an overvoltage condition of the input 100i is present. The voltage provided by the voltage limiter 110 may be proportional to a voltage of the overvoltage condition applied to the high voltage line 102. With more specificity, the voltage applied to the delay/LIP enable circuit 120 can be used to, for example, charge a capacitor or a plurality of capacitors, as will be described in more detail in the following, although any suitable signal can be used to initiate and power the timer function of the delay/LIP enable circuit.

As can be appreciated, scaling of the timer-based fault protection circuit 100 is possible. That is, alternative components values, topologies, or the like can be employed for higher or lower voltage applications. Accordingly, principles and procedures related to the timer-based fault protection circuit 100 may be used to scale this circuit to support high power requirement. By way of illustration, scaling of the timer-based fault protection circuit 100 may be achieved by, for example, using a higher power SCR 130D and series resistor 130R. Exemplary principles and procedures of the timer-based fault protection circuit 100, as well as other timer-based fault protection circuits, are discussed in more detail in the following.

### Detailed Example of a Timer-Based Fault Protection Circuit

FIG. 2 shows a more detailed view of the timer-based fault protection circuit 100 described with reference to FIG. 1. As shown in FIG. 2, the timer-based fault protection circuit 100 includes the input 100i, the high voltage line 102, the intrinsic safety load ISL, and the low voltage line 104. Also shown in FIG. 2, the timer-based fault protection circuit 100 includes the voltage limiter 110, the delay/LIP enable circuit 120, the switchable low impedance path 130, and the TVS diode 140 described with reference to FIG. 1.

As shown in FIG. 2, the voltage limiter 110 is comprised of a voltage divider 112, a first voltage adjustable shunt regulator 114, and a delay circuit switch 116. Also as shown in FIG. 2, the delay/LIP enable circuit 120 is comprised of a resistor-capacitor

(RC) network 123, a second voltage adjustable shunt regulator 124, and an SCR enable switch 126. The switchable low impedance path 130 is shown as including the SCR 130D and the series resistor 130R described with reference to FIG. 1. The TVS diode 140 described with reference to FIG. 1 is shown in FIG. 2 as including four TVS diodes, although more or fewer diodes and/or other elements may be employed.

The voltage divider 112 is comprised of a first resistor R1 and a second resistor R2 electrically connected in series. A first terminal of the first resistor R1 is electrically coupled to the high voltage line 102 and a second terminal of the first resistor R1 is electrically coupled to a first terminal of the second resistor R2. A second terminal of the second resistor R2 is electrically coupled to the low voltage line 104. A first voltage reference V1 is between the first and second resistor R1, R2 of the voltage divider 112.

The first voltage adjustable shunt regulator 114 is shown as being electrically coupled to the high voltage line 102 via a third resistor R3 and the low voltage line 104. The first voltage adjustable shunt regulator 114 is therefore electrically parallel to the terminal of the input 100i. The first voltage adjustable shunt regulator 114 is also shown having a voltage reference V_{REF} terminal that is electrically coupled to the first voltage reference V1 between the first and second resistors R1, R2 of the voltage divider 112.

The delay circuit switch 116 is shown as a bipolar junction transistor (BJT). In particular, as shown, the delay circuit switch 116 is model BCX52, which may be, with more specificity, model BCX52-16, 115, available from various manufacturers, although any suitable switch may be employed. The delay circuit switch 116 includes an emitter that is electrically coupled to the high voltage line 102, a base that is electrically coupled to a third resistor R3 and a fourth resistor R4, and a collector that is electrically coupled to a first terminal of voltage drop resistor 122. As shown in FIG. 2, a second terminal of the third resistor R3 and a first terminal of the fourth resistor R4 is electrically coupled to the base of the delay circuit switch 116 and a second terminal of the fourth resistor R4 is electrically coupled to a first terminal of the first voltage adjustable shunt regulator 114. A second terminal of the first voltage adjustable shunt regulator 114 is electrically coupled to the low voltage line 104.

As shown in FIG. 2, the voltage drop resistor 122 includes a first terminal that is electrically coupled to the collector of the delay circuit switch 116. With more specificity, the collector of the delay circuit switch 116 is electrically coupled to a first terminal of a fifth resistor R5. As shown in FIG. 2, the voltage drop resistor 122 is shown as being comprised of the fifth resistor R5, although alternative voltage drop resistors may include more than one resistor.

A first terminal of the RC network 123 is electrically coupled to a second terminal of the voltage drop resistor 122. A second terminal of the RC network 123 is electrically coupled to the low voltage line 104. The RC network 123 is shown in FIG. 2 as being comprised of a sixth resistor R6 and a capacitor C that are parallel to each other. With more specificity, a first terminal of the sixth resistor R6 and a first terminal of the capacitor C are electrically coupled to each other. Additionally, a second terminal of the sixth resistor R6 and a second terminal of the capacitor C are electrically coupled to the low voltage line 104.

The first terminal of the RC network 123 is also electrically coupled to a voltage reference terminal V_{REF} of the second voltage adjustable shunt regulator 124. The second voltage adjustable shunt regulator 124 includes a first terminal that is electrically coupled to a second terminal of a seventh resistor R7. A second terminal of the second voltage adjustable shunt regulator 124 is electrically coupled to the low voltage line 104. As shown in FIG. 2, the second terminal of the second voltage adjustable shunt regulator 124 is directly coupled to the low voltage line 104 although indirect electrical couplings may be employed, such as low resistive path.

A first terminal of an eighth resistor R8 is electrically coupled to the high voltage line 102. A second terminal of the eighth resistor R8 is electrically coupled to an emitter of the SCR enable switch 126. A first terminal of the seventh resistor R7 is electrically coupled to a base of the SCR enable switch 126. The SCR enable switch 126 includes an emitter that is electrically coupled to the high voltage line 102 via the eighth resistor R8 and a collector that is electrically coupled to the switchable low impedance path 130. The SCR enable switch 126 is shown as a BJT although any suitable switch may be employed. The SCR enable switch 126 is shown in FIG. 2 as a BCX52 transistor available from various manufacturers. For example, the SCR enable switch 126 may be a BCX52-16, 115 transistor.

A first terminal of a ninth resistor R9 is electrically coupled to the high voltage line 102. A second terminal of the ninth resistor R9 is electrically coupled to the first terminal of the seventh resistor R7. The seventh resistor R7 and the ninth resistor R9 electrically couple the second voltage adjustable shunt regulator 124 to the high voltage line 102. The second terminal of the ninth resistor R9 is also electrically coupled to the base of the SCR enable switch 126. As can be appreciated, the ninth resistor R9 provides a voltage to the base of the SCR enable switch 126. As can also be appreciated, this voltage may be reduced when the second voltage adjustable shunt regulator 124 conducts a current, as will be described in more detail below.

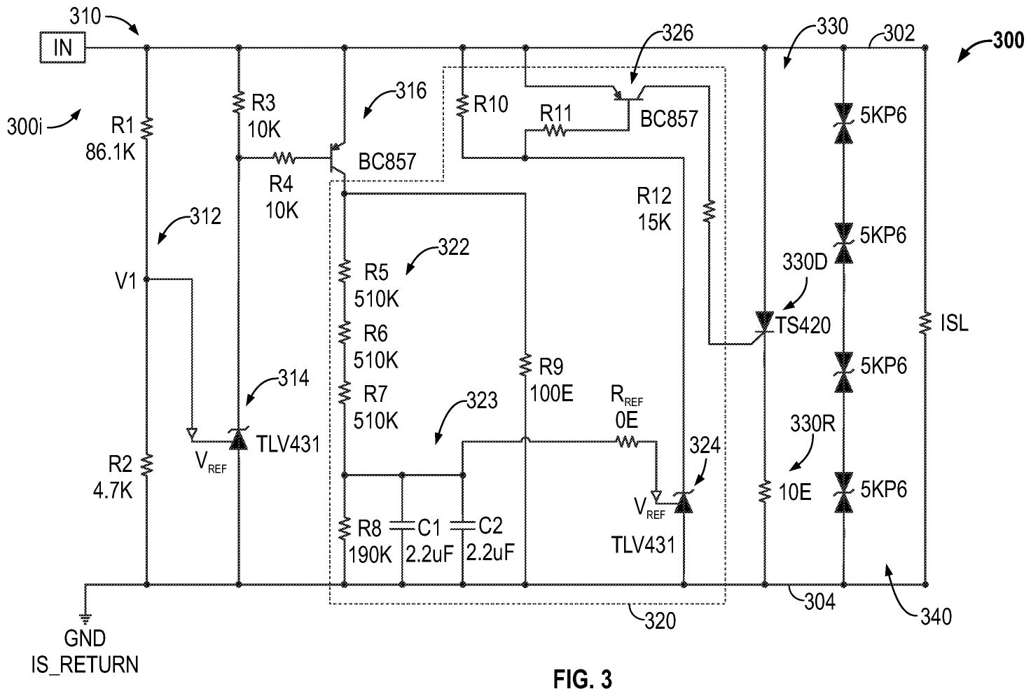

As shown in FIG. 2, the switchable low impedance path 130 includes the SCR 130D and the series resistor 130R described with reference to FIG. 1. A first terminal and a second terminal of the SCR 130D are respectively electrically coupled to the high voltage line 102 and the low voltage line 104. As shown in FIG. 3, the second terminal of the SCR 130D is electrically coupled to the low voltage line 104 via the series resistor 130R, although the SCR 130D may be directly electrically coupled to the low voltage line 104. The series resistor 130R may be referred to as a tenth resistor. The SCR 130D and the series resistor 130R are arranged in series as shown in FIG. 2. The SCR 130D is shown as being an SJ6008D, such as, for example, a SJ6008D1RP, manufactured by Littelfuse, although any suitable silicon-controlled rectifier, thyristor, or the like may be employed. The SCR 130D includes a gate that is electrically coupled to the collector of the SCR enable switch 126.

As discussed above and shown in FIG. 2, the TVS diode 140 is comprised of two transient voltage suppression diodes arranged in an electrically parallel configuration. In particular, the TVS diode 140 is shown as being comprised of two 5.0SMDJ diodes manufactured by Littelfuse, although any suitable TVS diode(s) may be employed. The TVS diode 140 is arranged as described with reference to FIG. 1. More specifically, the first terminal of the TVS diode 140 is electrically coupled to the high voltage line 102 and the second terminal of the TVS diode 140 is electrically coupled to the low voltage line 104. The TVS diode 140 is electrically parallel with the intrinsically safe load ISL.

The first and second voltage adjustable shunt regulator 114, 124 may be TL431 shunt regulators manufactured by various manufacturers, although any suitable adjustable shunt regulator may be employed. As shown in FIG. 2, the first and second voltage adjustable shunt regulator 114, 124 include a voltage reference terminal V_{REF}. The first and second voltage adjustable shunt regulator 114, 124 may conduct current when a voltage at the voltage reference terminal V_{REF} is greater than the voltage reference value internal to the first and second voltage adjustable shunt regulator 114, 124. When the voltage at the voltage reference terminal V_{REF} is less than the voltage reference value internal to the first and second voltage adjustable shunt regulator 114, 124, the first and second voltage adjustable shunt regulator 114, 124 may not conduct.

For example, in the voltage limiter 110 shown in FIG. 2, when the voltage of the high voltage line 102 is greater than a voltage threshold value such that the first voltage reference V1 value is greater than the voltage reference value of the first voltage adjustable shunt regulator 114, then the first voltage adjustable shunt regulator 114 may conduct. As can be appreciated, the first voltage reference V1 may be determined from the resistance values of the first and second resistors R1, R2 of the voltage limiter 110. In the delay/LIP enable circuit 120, the second voltage adjustable shunt regulator 124 may conduct when the voltage of the first terminal of the RC network 123 is greater than the voltage reference value of the second voltage adjustable shunt regulator 124.

As can be appreciated, when the first voltage adjustable shunt regulator 114 conducts current, a voltage at the base of the delay circuit switch 116 drops to a relatively low state or value, thereby increasing a voltage difference between the base and the emitter of the delay circuit switch 116. The increase in voltage difference between the base and the emitter of the delay circuit switch 116 can cause the delay circuit switch 116 to conduct a current between the emitter and collector of the delay circuit switch 116. This can result in a voltage being applied to the first terminal of the RC network 123 and may therefore begin to charge the capacitor C of the RC network 123 to initiate the timer function of the delay/LIP enable circuit 120.

Similarly, when the second voltage adjustable shunt regulator 124 conducts current, a voltage at the base of the SCR enable switch 126 drops to a low voltage state or value (e.g., at or about zero volts), thereby increasing a voltage difference between the base and the emitter of the SCR enable switch 126. The increase in voltage difference between the base and the emitter of the SCR enable switch 126 can cause the SCR enable switch 126 to conduct a current between the emitter and collector of the SCR enable switch 126. This can cause a gate voltage and current to be applied at the gate of the SCR 130D.

When the gate voltage and current are applied at the gate of the SCR 130D, the SCR 130D may conduct a forward conduction current between its first and second terminal. The SCR 130D may continue to conduct the forward conduction current between the first and second terminal even if the gate voltage and current at the gate of the SCR 130D return to zero. Accordingly, a temporary increase in the gate voltage and current, such as a pulse, at the gate of the SCR 130D may only be necessary to cause the SCR 130D to conduct. However, the SCR 130D may stop conducting the forward conduction current between the first and second terminals if the gate voltage of the gate of the SCR 130D returns to, for example, zero and the current between the first and second terminal falls to less than a hold current of the SCR 130D. For example, where the hold current of the SCR 130D is very low, the SCR 130D may continue to conduct the forward conduction current until the voltage of the high voltage line 102 is at or about zero volts (e.g., “pulled to ground”).

As can be appreciated, a calculated current value of the series resistor 130R for a voltage on the high voltage line 102 under operating conditions or non-overvoltage condition may be zero or less than the latching current of the SCR 130D. In contrast, a current through the series resistor 130R may be greater than the latching value of the SCR 130D when the high voltage line 102 is subject to an overvoltage condition.

Accordingly, when the SCR 130D is enabled by a gate voltage and current to conduct a forward conduction current, the SCR 130D may conduct the forward conduction current, for example, when the high voltage line 102 is subject to an overvoltage condition.

In normal operation, which may be defined as when the input 100i is not subject to overvoltage condition, the delay circuit switch 116 and the SCR enable switch 126 are not conducting a current. More specifically, the bases of the delay circuit switch 116 and SCR enable switch 126 do not have a voltage that is sufficient to cause a current to conduct between the respective emitters and collectors of the delay circuit switch 116 and SCR enable switch 126. Accordingly, a gate voltage and current are not applied to the gate of the SCR 130D unless the input 100i is subject to an overvoltage condition.

Referring to the delay circuit switch 116, when the high voltage line 102 is not subject to an overvoltage condition, because there is no current between the emitter and collector of the delay circuit switch 116, a voltage is not applied to the first terminal of the RC network 123. As a result, the reference voltage terminal of the second voltage adjustable shunt regulator 124 may have a voltage that is lower than a reference voltage of the second voltage adjustable shunt regulator 124. The voltage at the first terminal of the second voltage adjustable shunt regulator 124 may therefore be greater than a voltage below which the SCR enable switch 126 will conduct a current. As a result, when the high voltage line 102 is not subject to an over-voltage condition, the switchable low impedance path 130 may remain open thereby preventing current from conducting through the switchable low impedance path 130. More specifically, the SCR 130D may not conduct a forward conduction current.

When the input 100i has an overvoltage condition, a voltage of the high voltage line 102 may cause the first voltage reference V1 value to be greater than the voltage reference value internal to the first voltage adjustable shunt regulator 114. As a result, a voltage of the base of the delay circuit switch 116 may be sufficiently low enough (e.g., low voltage state or value) to cause the delay circuit switch 116 to conduct a current between the collector and emitter of the delay circuit switch 116. This may cause a voltage to be applied to the first terminal of the RC network 123.

The voltage of the first terminal of the RC network 123 may therefore increase over time. That is, the capacitor C of the RC network 123 may charge when the high voltage line 102 is subject to an over-voltage condition. When the voltage of the first terminal of the RC network 123 is greater than the voltage reference value of the second voltage adjustable shunt regulator 124, then the second voltage adjustable shunt regulator 124 may conduct thereby causing the SCR enable switch 126 to conduct current between the emitter and collector of the SCR enable switch 126.

As a result, due to the overvoltage condition of the high voltage line 102, the switchable low impedance path 130 may close thereby allowing a relatively high forward conduction current to conduct through the switchable low impedance path 130. More specifically, the SCR 130D may conduct, thereby allowing the forward conduction current to conduct from the high voltage line 102 to the low voltage line 104 via the SCR 130D and the series resistor 130R.

Due to the high forward conduction current through the switchable low impedance path 130, the voltage value of the high voltage line 102 may decrease or drop. For example, if the overvoltage condition of the high voltage line 102 is due to a transient voltage being applied to the high voltage line 102, the voltage value of the high voltage line 102 may decrease due to the forward conduction current through the switchable low impedance path 130. As can also be appreciated, the decrease in the voltage value of the high voltage line 102 may cause the delay circuit switch 116 to open thereby preventing a current from flowing to the RC network 123.

As a result, the capacitor C may discharge through the sixth resistor R6 into the low voltage line 104, which may be, for example, a ground. This can cause the voltage value of the first terminal of the RC network 123 to decrease over time. When the voltage of the first terminal of the RC network 123 decreases to a voltage value that is less than the voltage reference value V_{REF} of the second voltage adjustable shunt regulator 124, then the SCR enable switch 126 may open thereby removing a gate voltage and current from the gate of the SCR 130D. However, the SCR 130D may continue to conduct the forward conduction current until the high voltage line 102 is at zero volts (e.g., pulled to ground), as is explained above.

As can be appreciated, there are various possible ways of implementing a timer-based fault protection circuit. The timer-based fault protection circuit 100 discussed above may be advantageous due to using relatively few components. However, other timer-based fault protection circuits may be employed that use different components and/or topologies, as the following example illustrates.

### Alternative Detailed Example of a Timer-Based Fault Protection Circuit

FIG. 3 shows an alternative timer-based fault protection circuit 300. As shown in FIG. 3, the timer-based fault protection circuit 300 includes an input 300i, a high voltage line 302, an intrinsic safety load ISL, and a low voltage line 304, which respectively correspond to the input 100i, the high voltage line 102, the intrinsic safety load ISL, and the low voltage line 104 described above with reference to FIG. 2. Also, as shown in FIG. 3, the timer-based fault protection circuit 300 includes a voltage limiter 310, a delay/LIP enable circuit 320, a switchable low impedance path 330, and a TVS diode 340, which also respectively correspond to the voltage limiter 110, the delay/LIP enable circuit 120, the switchable low impedance path 130, and the TVS diode 140 described with reference to FIG. 2. In contrast to the timer-based fault protection circuit 100 shown in FIG. 2, the TVS diode 340 of FIG. 3 is illustrated proximate the intrinsic safety load ISL.

As shown in FIG. 3, the voltage limiter 310 is comprised of a voltage divider 312, a first voltage adjustable shunt regulator 314, and a delay circuit switch 316. Also as shown in FIG. 3, the delay/LIP enable circuit 320 is comprised of a resistor-capacitor (RC) network 323, a second voltage adjustable shunt regulator 324, and an SCR enable switch 326. The switchable low impedance path 330 is shown as including the SCR 330D and the series resistor 330R described with reference to FIG. 1. The TVS diode 140 described with reference to FIG. 1 is shown in FIG. 3 as including four TVS diodes, although more or fewer diodes and/or other elements may be employed.

The voltage divider 312 is comprised of a first resistor R1 and a second resistor R2 electrically connected in series. A first terminal of the first resistor R1 is electrically coupled to the high voltage line 302 and a second terminal of the first resistor R1 is electrically coupled to a first terminal of the second resistor R2. A second terminal of the second resistor R2 is electrically coupled to the low voltage line 304. A first voltage reference V1 is between the first and second resistor R1, R2 of the voltage divider 312.

The first voltage adjustable shunt regulator 314 is shown as being electrically coupled to the high voltage line 302 via a third resistor R3 and the low voltage line 304. The first voltage adjustable shunt regulator 314 is therefore electrically parallel to the terminal of the input 300i. The first voltage adjustable shunt regulator 314 is also shown having a voltage reference V_{REF} terminal that is electrically coupled to the first voltage reference V1 between the first and second resistors R1, R2 of the voltage divider 312.

The delay circuit switch 316 is shown as a bipolar junction transistor (BJT), in particular model BC857 available from various manufacturers, although any suitable switch may be employed. The delay circuit switch 316 includes an emitter that is electrically coupled to the high voltage line 302, a base that is electrically coupled to a fourth resistor R4, and a collector that is electrically coupled to a first terminal of voltage drop resistors 322. As shown in FIG. 3, a first terminal of the fourth resistor R4 is electrically coupled to the base of the delay circuit switch 316 and a second terminal of the fourth resistor R4 is electrically coupled to a second terminal of the third resistor R3.

As shown in FIG. 3, the voltage drop resistors 322 includes a first terminal that is electrically coupled to the collector of the delay circuit switch 316. With more specificity, the collector of the delay circuit switch 316 is electrically coupled to a first terminal of a fifth resistor R5. The fifth resistor R5, a sixth resistor R6, and a seventh resistor R7 are electrically coupled to each other in series.

The collector of the delay circuit switch 316 is also electrically coupled to a ninth resistor R9. More specifically, the ninth resistor R9 has a first terminal that is electrically coupled to the collector of the delay circuit switch 316 and a second terminal that is electrically coupled to the low voltage line 304. Accordingly, the voltage drop resistors 322 is also electrically coupled in parallel with the ninth resistor R9.

A first terminal of the RC network 323 is electrically coupled to a second terminal of the voltage drop resistors 322. A second terminal of the RC network 323 is electrically coupled to the low voltage line 304. The RC network 323 is shown in FIG. 3 as being comprised of an eighth resistor R8, a first capacitor C1, and a second capacitor C2 that are electrically parallel to each other. With more specificity, a first terminal of the eighth resistor R8, the first capacitor C1, and the second capacitor C2 are electrically coupled to each other. Additionally, a second terminal of the eighth resistor R8, the first capacitor C1, and the second capacitor C2 are electrically coupled to the low voltage line 304.

The first terminal of the RC network 323 is also electrically coupled to, via a reference terminal resistor R_{REF}, a voltage reference terminal V_{REF} of the second voltage adjustable shunt regulator 324. The second voltage adjustable shunt regulator 324 includes a first terminal that is electrically coupled to a second terminal of a tenth and eleventh resistor R10, R11. A second terminal of the second voltage adjustable shunt regulator 324 is electrically coupled to the low voltage line 304. As shown in FIG. 3, the second terminal of the second voltage adjustable shunt regulator 324 is directly coupled to the low voltage line 304 although indirect electrical couplings may be employed, such as low resistive path.

A first terminal of the tenth resistor R10 is electrically coupled to the high voltage line 302. A first terminal of the eleventh resistor R11 is electrically coupled to a base of the SCR enable switch 326. The SCR enable switch 326 includes an emitter that is electrically coupled to the high voltage line 302 and a collector that is electrically coupled to a first terminal of a twelfth resistor R12. A second terminal of the twelfth resistor R12 is electrically coupled to the switchable low impedance path 330.

As shown in FIG. 3, the switchable low impedance path 330 includes an SCR 330D and the series resistor 330R that respectively correspond to the SCR 130D and the series resistor 130R described with reference to FIG. 1. A first terminal and a second terminal of the SCR 330D are respectively electrically coupled to the high voltage line 302 and the low voltage line 304. As shown in FIG. 3, the second terminal of the SCR 330 is electrically coupled to the low voltage line 304 via the series resistor 330R, although the SCR 330D may be directly electrically coupled to the low voltage line 304. The series resistor 330R may be referred to as a thirteenth resistor. The SCR 330D and the series resistor 330R are arranged in series as shown in FIG. 1. The SCR 330D is shown as being a TS420 SCR, such as, for example, a TS420-600B-TR SCR, manufactured by STMicroelectronics, although any suitable silicon-controlled rectifier or thyristor may be employed. The SCR 330D includes a gate that is electrically coupled to the second terminal of the twelfth resistor R12. A first terminal of the twelfth resistor R12 is electrically coupled to the collector of the SCR enable switch 326.

As discussed above and shown in FIG. 3, the TVS diode 340 is comprised of four transient voltage shunt diodes. In particular, the TVS diode 340 is shown as being comprised of four 5KP6 TVS diodes manufactured by Littelfuse. The four 5KP6 TVS diodes are in series, although any suitable circuit may be employed. The TVS diode 340 is arranged the same as the TVS diode 140 described with reference to FIG. 1. More specifically, the first terminal of the TVS diode 340 is electrically coupled to the high voltage line 302 and the second terminal of the TVS diode 340 is electrically coupled to the low voltage line 304. The TVS diode 340 is electrically parallel with the intrinsically safe load ISL.

The first and second voltage adjustable shunt regulator 314, 324 may be TLV431 shunt regulators manufactured by Texas Instruments, although any suitable adjustable shunt regulator may be employed. As shown in FIG. 3, the first and second voltage adjustable shunt regulator 314, 324 include a voltage reference terminal V_{REF}. The first and second voltage adjustable shunt regulator 314, 324 may conduct current when a voltage at the voltage reference terminal V_{REF} is greater than the voltage reference value internal to the first and second voltage adjustable shunt regulator 314, 324. When the voltage at the voltage reference terminal V_{REF} is less than the voltage reference value internal to the first and second voltage adjustable shunt regulator 314, 324, the first and second voltage adjustable shunt regulator 314, 324 may not conduct.

For example, in the voltage limiter 310 shown in FIG. 3, when the voltage of the high voltage line 302 is greater than a voltage threshold value such that the first voltage reference V1 value is greater than the voltage reference value of the first voltage adjustable shunt regulator 314, then the first voltage adjustable shunt regulator 314 may conduct. As can be appreciated, the first voltage reference V1 value may be determined from the resistance values of the first and second resistors R1, R2 of the voltage limiter 310. In the delay/LIP enable circuit 320, the second voltage adjustable shunt regulator 324 may conduct when the voltage of the first terminal of the RC network 323 is greater than the voltage reference value of the second voltage adjustable shunt regulator 324.

As can be appreciated, when the first voltage adjustable shunt regulator 314 conducts current, a voltage at the base of the delay circuit switch 316 drops to a low state or value (e.g., at or about zero volts), thereby increasing a voltage difference between the base and the emitter of the delay circuit switch 316. The increase in voltage difference between the base and the emitter of the delay circuit switch 316 can cause the delay circuit switch 316 to conduct a current between the emitter and collector of the delay circuit switch 316. This can result in a voltage being applied to the first terminal of the RC network and may therefore begin to charge the first and second capacitors C1, C2 of the RC network 323 to initiate the timer function of the delay/LIP enable circuit 320.

Similarly, when the second voltage adjustable shunt regulator 324 conducts current, a voltage at the base of the SCR enable switch 326 drops to a low voltage state or value (e.g., at or about zero volts), thereby increasing a voltage difference between the base and the emitter of the SCR enable switch 326. The increase in voltage difference between the base and the emitter of the SCR enable switch 326 can cause the SCR enable switch 326 to conduct a current between the emitter and collector of the SCR enable switch 326. This can cause a gate voltage and current to be applied at the gate of the SCR 130D.

When the gate voltage and current are applied at the gate of the SCR 330D, the SCR 330D may conduct a forward conduction current between its first and second terminal. The SCR 330D may continue to conduct the forward conduction current between the first and second terminal even if the gate voltage and current at the gate returns to zero. Accordingly, a temporary increase in the gate voltage and current, such as a pulse, at the gate may only be necessary to cause the SCR 330D to conduct. However, the SCR 330D may stop conducting the forward conduction current between the first and second terminals if the gate voltage and current of the gate return to, for example, zero and the forward conduction current between the first and second terminal falls to less than a hold current of the SCR 330D.

As can be appreciated, a calculated current value of the series resistor 330R for a voltage on the high voltage line 302 under operating conditions or non-overvoltage condition may be zero or less than the latching value of the SCR 330D. In contrast, a current through the series resistor 330R may be greater than the latching value of the SCR 330D when the high voltage line 302 is subject to an overvoltage condition. Accordingly, when the SCR 330D is enabled by a voltage to conduct a forward conduction current, the SCR 330D may conduct the forward conduction current, for example, when the high voltage line 302 is subject to an overvoltage condition.

In normal operation, which may be defined as when the input 300i is not subject to overvoltage condition, the delay circuit switch 316 and the SCR enable switch 326 are not conducting a current. More specifically, the bases of the delay circuit switch 316 and SCR enable switch 326 do not have a voltage that is sufficient to cause a current to conduct between the respective emitters and collectors of the delay circuit switch 316 and SCR enable switch 326.

Referring to the delay circuit switch 316, when the high voltage line 302 is not subject to an overvoltage condition, because there is no current between the emitter and collector of the delay circuit switch 316, a voltage is not applied to the first terminal of the RC network 323. As a result, the reference voltage terminal of the second voltage adjustable shunt regulator 324 may have a voltage that is lower than a reference voltage of the second voltage adjustable shunt regulator 324. The voltage at the first terminal of the second voltage adjustable shunt regulator 324 may therefore be greater than a voltage below which the SCR enable switch 326 will conduct a current. As a result, when the high voltage line 302 is not subject to an over-voltage condition, the switchable low impedance path 330 remains open thereby preventing current from conducting through the switchable low impedance path 330. More specifically, the SCR 330D may not conduct a forward conduction current.

When the input 300i has an overvoltage condition, a voltage of the high voltage line 302 may cause the first voltage reference VI value to be greater than the voltage reference value internal to the first voltage adjustable shunt regulator 314. As a result, a voltage of the base of the delay circuit switch 316 may be sufficiently low enough (e.g., low voltage state or value) to cause the delay circuit switch 316 to conduct a current between the collector and emitter of the delay circuit switch 316. This may cause a voltage to be applied to the first terminal of the RC network 323.

The voltage of the first terminal of the RC network 323 may therefore increase over time. That is, the first and second capacitors C1, C2 of the RC network 323 may charge when the high voltage line 302 is subject to an over-voltage condition. When the voltage of the first terminal of the RC network 323 is greater than the voltage reference value of the second voltage adjustable shunt regulator 324, then the second voltage adjustable shunt regulator 324 may conduct thereby causing the SCR enable switch 326 to conduct current between the emitter and collector of the SCR enable switch 326.

As a result, due to the overvoltage condition of the high voltage line 302, the switchable low impedance path 330 may close thereby allowing a forward conduction current to conduct through the switchable low impedance path 330. More specifically, the SCR 330D may conduct, thereby allowing the forward conduction current to conduct from the high voltage line 302 to the low voltage line 304 via the SCR 330D and the series resistor 330R.

Due to the high forward conduction current through the switchable low impedance path 330, the voltage value of the high voltage line 302 may decrease or drop. For example, if the overvoltage condition of the high voltage line 302 is due to a transient voltage being applied to the high voltage line 302, the voltage value of the high voltage line 302 may decrease due to the forward conduction current through the switchable low impedance path 330. As can also be appreciated, the decrease in the voltage value of the high voltage line 302 may cause the delay circuit switch 316 to open thereby preventing a current from flowing to the RC network 323.

As a result, the first and second capacitor C1, C2 may discharge through the eighth resistor R8 into the low voltage line 304, which may be, for example, a ground. This can cause the voltage value of the first terminal of the RC network 323 to decrease over time. When the voltage of the first terminal decreases to a voltage value that is less than the voltage reference value V_{REF} of the second voltage adjustable shunt regulator 324, then the SCR enable switch 326 may open thereby removing a gate voltage and current from the gate of the SCR 330D. However, the SCR 330D may continue to conduct the forward conduction current until the high voltage line 102 is at zero volts (e.g., pull to ground), as is explained above.

### Operation of the Timer-Based Protection Circuits

As can be appreciated, the voltage limiter 110, 310, the delay/LIP enable circuit 120, 320, and the switchable low impedance path 130, 330 may work together such that a current may conduct through the TVS diode 140, 340 for a predetermined time-period. This predetermined time-period may be selected so as to ensure that the TVS diode 140, 340 do not experience a catastrophic failure. For example, a sequence of events may be as follows. An over-voltage condition applied to the input 100i, 300i may cause the voltage limiter 110, 310 to enable a timer function of the delay/LIP enable circuit 120, 320.

Therefore, the voltage limiter 110, 310 and the delay/LIP enable circuit 120, 320 may prevent a false triggering of the switchable low impedance path 130, 330 by requiring a delay before triggering the switchable low impedance path 130, 330. After the predetermined time-period, which may be at or about a charging time of the capacitor(s) of the RC network 123, 323, the delay/LIP enable circuit 120, 320 may provide a signal to the switchable low impedance path 130, 330. The signal may cause the switchable low impedance path 130, 330 to conduct a forward conduction current between the high voltage line 102, 302 and the low voltage line 104, 304. As a result, the voltage value of the high voltage line 102, 302 may decrease or drop to a value that causes the voltage limiter 110, 310 to not apply a voltage to the delay/LIP enable circuit 120, 320. As a result, the delay/LIP enable circuit 120, 320 may not apply the signal to the switchable low impedance path 130, 330.

However, even though the switchable low impedance path 130, 330 is no longer receiving the signal, the switchable low impedance path 130, 330 may still conduct a forward conduction current as long as the current between the high voltage line 102, 302 and the low voltage line 104, 304 is greater than a holding current of the switchable low impedance path 130, 330. The forward conduction current through the switchable low impedance path 130, 330 may be greater than the holding current as long as the input 100i, 300i are subject to an over-voltage condition, or any voltage at all, depending on the holding current of the low impedance path 130, 330.

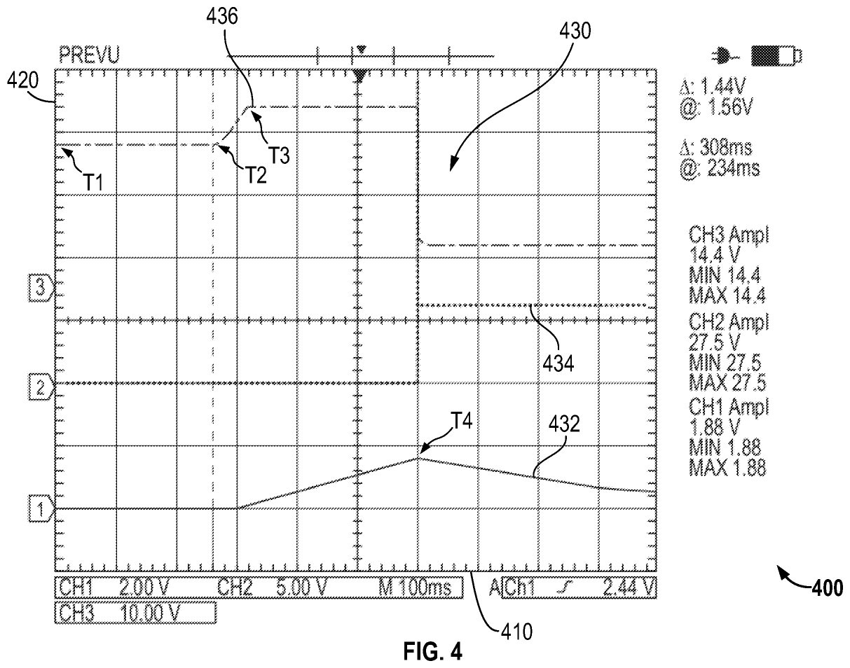

As can also be appreciated, while the switchable low impedance path 130, 330 is conducting, current may not be conducting through the TVS diode 140, 340. That is, a voltage value at which the switchable low impedance path 130, 330 is conducting current may be less than a voltage value (e.g., breakdown voltage) necessary to conduct current through the TVS diode 140, 340. The timing of the above is discussed in more detail in the following with reference to FIG. 4.

### Exemplary Timing Diagram

FIG. 4 shows a timing diagram 400 illustrating a timing of a timer-based fault protection circuit, such as the timer-based fault protection circuits 100, 300 discussed above with reference to FIGS. 1-3. As shown in FIG. 3, the timing diagram 400 includes a time axis 410 in units of milli-seconds (ms) and a voltage axis 420 in units of volts (V). The scale of the time axis 410 is 100 ms per major line demarcation. The time axis 410 has ten major line demarcations. Accordingly, the time axis 410 has a span of 1000 ms or 1 second. The scale of the voltage axis is channel dependent, where each channel is indicated on the timing diagram by a channel numbered arrow on the left side of the timing diagram 400. The voltage scale is 2.00 V for channel 1 Ch1, 5.00 V for channel 2 Ch2, and 10.0 V for channel 3 Ch3.

The timing diagram 400 also includes voltage plots 430 that is comprised of a timer capacitor voltage plot 432, SCR series resistor voltage plot 434, and a supply line voltage plot 436. The timer capacitor voltage plot 432 is associated with channel 1 Ch1, the SCR series resistor voltage plot 434 is associated with channel 2 Ch2, and the supply line voltage plot 436 is associated with channel 3 Ch3. From 0 ms to about 300 ms, the timer capacitor voltage plot 432 is at about zero volts. From about 300 ms to about 600 ms, the timer capacitor voltage plot 432 increases from zero to about 1.88 V. The period from about 300 ms to about 600 ms illustrates the function of the timer-based fault protection circuits 100, 300 discussed above, as will be explained in more detail in the following.

From time T1 to T2 a normal operating voltage of 22 V is applied to the inputs 100i, 300i of the timer-based fault protection circuits 100, 300. Accordingly, the supply line voltage plot 436 remains at 22 V. Similarly, the timer capacitor voltage plot 432 remains at zero indicating that the voltage limiter 110, 310 has not yet begun applying a voltage to the first terminal of the RC network 123, 323. This is because the reference voltage V1 has not yet exceeded a voltage reference value internal to the first voltage adjustable shunt regulator 114, 314.

From time T2 to T3, the supply line voltage plot 336 increases from 22 V to about 29 V due to a fault voltage of 32 V being applied to the input 100i, 300i. That is, TVS diode 140, 340 prevents the voltage of the high voltage line 102, 302 from exceeding a threshold voltage, such as a breakdown voltage, of the TVS diode 140, 340. However, the TVS diode 140, 340 may necessarily conduct a significant amount of current to do so. The TVS diode 140, 340 may be well-suited to prevent transient or very short duration high voltage events, but may not be as well suited as, for example, an SCR, thyristor, or the like, to conduct current during overvoltage conditions that last longer than transient event time-periods. For example, the TVS diode 140, 340 may tend to fail after conducting a current for more than a few seconds. Accordingly, to prevent this from occurring, a timing described in the following may be employed, although any suitable timing and timer-based fault protection circuit can be used.

Shortly after the fault voltage of 32 V is applied at time T2, the timer capacitor voltage plot 432 begins to increase from zero volts. This is due to the voltage limiter 110, 310 causing the delay circuit switch 116, 316 to apply a voltage and hence the charging current to the first terminal of the RC network 123, 323. At time T3, the supply line voltage plot 436 levels at about 29 V due to the TVS diode 140, 340 conducting at a breakdown voltage.

From time T3 to T4, the supply line voltage plot 436 remains at about 29 V and the timer capacitor voltage plot 432 continues to increase. This is due to the delay circuit switch 116 continuing to apply the voltage to the first terminal of the RC network 123, 323. The SCR series resistor voltage plot 434 remains at zero volts because the SCR enable switch 126, 326 has not enabled the SCR 130D, 330D.

At time T4, the voltage on the first terminal of the RC network 123, 323 causes the second voltage adjustable shunt regulator 124, 324 to close thereby allowing the SCR enable switch 126, 326 to cause the switchable low impedance path 130, 330 to close. This conducts a current through the switchable low impedance path 130, 330. With more specificity, the SCR enable switch 126, 326 applies a non-zero gate voltage and sufficient gate current to the gate of the SCR 130D, 330D, which causes the SCR 130D, 330D to conduct.

As a result, at time T4, the supply line voltage plot 436 drops from 29 V to about 7 V. Substantially simultaneously, the SCR series resistor voltage plot 434 increases from zero volts to about 7 volts. This is due to the SCR 130D, 330D conducting a current through the series resistor 130R, 330R. Accordingly, the following method 500 may be executed using the timer-based fault protection circuit 100, 300, or another similar timer-based fault protection circuit.

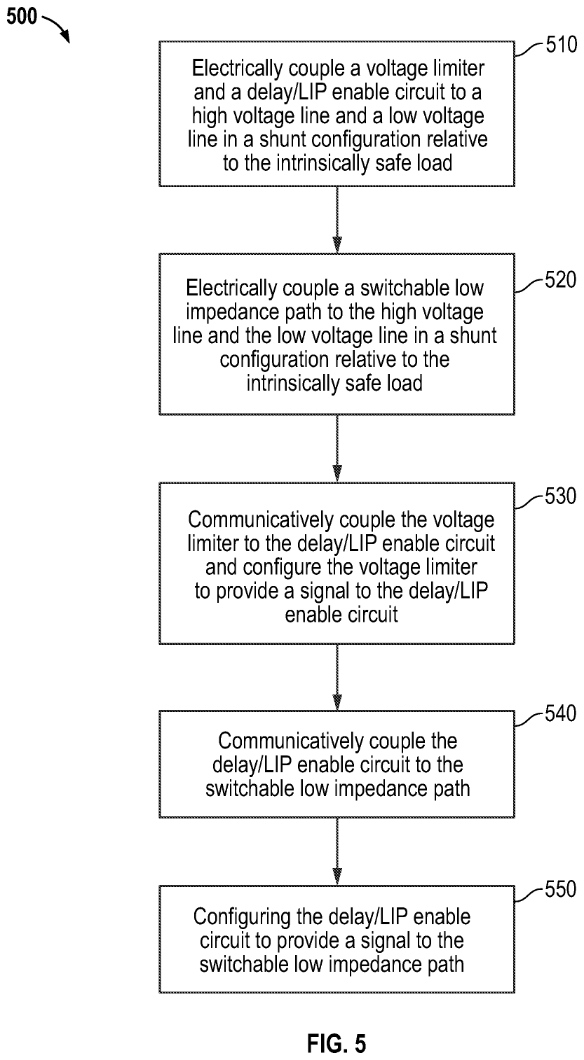

FIG. 5 shows a method 500 of forming a timer-based fault protection circuit. As shown in FIG. 5, the method 500 begins by electrically coupling a voltage limiter and a delay/LIP enable circuit to a high voltage line and a low voltage line electrically parallel to the intrinsically safe load in step 510. In step 520, the method 500 electrically couples a switchable low impedance path to the high voltage line and the low voltage line in a shunt configuration relative to the intrinsically safe load. The method 500, in step 530, communicatively couples the voltage limiter to the delay/LIP enable circuit and configures the voltage limiter to provide a signal to the delay/LIP enable circuit. In step 540, the method 500 communicatively couples the delay/LIP enable circuit to the switchable low impedance path and configures the delay/LIP enable circuit to provide a signal to the switchable low impedance path. In step 550, the method 500 may configure the delay/LIP enable circuit to provide a signal to the switchable low impedance path.

The method 500 may also configure the high voltage line to electrically couple to a first terminal of an intrinsically safe load and/or configure the low voltage line to electrically couple to a second terminal of the intrinsically safe load. For example, the method 500 may affix terminals, leads, connectors, another line, or the like, to ends of the high voltage line and/or the low voltage line. Additionally, the method 500 may further comprise electrically coupling a first terminal of a transient voltage suppression diode to the high voltage line and a second terminal to the low voltage line. The transient voltage suppression diode may be configured to conduct a current between the high voltage line and the low voltage line when a voltage of the high voltage line is greater than a breakdown voltage of the transient voltage suppression diode. The transient voltage suppression diode of method 500 may be the TVS diode 140, 340 described above, although any suitable transient voltage diode may be employed.

The method 500 may also further include the step of configuring the switchable low impedance path to conduct a current between the high voltage line and the low voltage line at a voltage that is less than a breakdown voltage of the transient voltage suppression diode when the signal is received from the delay/LIP enable circuit. The method 500 may also configure the voltage limiter to sense a voltage of the high voltage line relative to a voltage of the low voltage line and provide the signal to the delay/LIP enable circuit when the voltage of the high voltage line relative to the voltage of the low voltage line is greater than an over-voltage threshold value. The method 500 may also configure the delay/LIP enable circuit to receive the signal from the voltage limiter, initiate a timer function of the delay/LIP enable circuit when the signal is received from the voltage limiter, and provide the signal to the switchable low impedance path when the timer function reaches a delay threshold value.

The method 500, in step 510 may couple any suitable voltage limiter to the high voltage line and the low voltage line. For example, the voltage limiter of method 500 may be the voltage limiter 110, 310 described above. Accordingly, the voltage limiter of method 500 may be comprised of a voltage divider having a first terminal electrically coupled to the high voltage line and a second terminal electrically coupled to the low voltage line. The voltage divider may be configured to provide a reference voltage based on the voltage of the high voltage line relative to the voltage of the low voltage line. The voltage limiter of method 500 may be comprised of a first voltage adjustable shunt regulator having a first terminal electrically coupled to the high voltage line, a second terminal electrically coupled to the low voltage line, and a voltage reference terminal configured to receive the reference voltage. The first voltage adjustable shunt regulator may be configured to conduct current based on the reference voltage.

The method 500, also in step 510, may couple any suitable delay/LIP enable circuit to the high voltage line and the low voltage line. For example, the delay/LIP enable circuit of method 500 may comprise one of the delay/LIP enable circuit 120, 320 described above. Accordingly, the delay/LIP enable circuit of method 500 may comprise an RC network configured to receive the signal from the voltage limiter and charge one or more capacitors in the RC network to a voltage using the signal from the voltage limiter, a second voltage adjustable shunt regulator electrically coupled to the RC network and configured to receive the voltage of the one or more capacitors in the RC network and conduct a current based on the voltage of the one or more capacitors of the RC network, and an SCR enable switch electrically coupled to the second voltage adjustable shunt regulator. The SCR enable switch being configured to provide the signal to the switchable low impedance path when the second voltage adjustable shunt regulator conducts the current.

The second voltage adjustable shunt regulator may comprise a first terminal electrically coupled to the high voltage line and a base terminal of the SCR enable switch, a second terminal electrically coupled to the low voltage line, and a reference voltage terminal configured to receive the voltage of the one or more capacitors of the RC network. The second voltage adjustable shunt regulator is configured to conduct the current from the high voltage line to the low voltage line in proportion to the voltage of the one or more capacitors of the RC network.

The switchable low impedance path of step 520 may comprise an SCR having a first terminal electrically coupled to the high voltage line, a second terminal electrically coupled to the low voltage line, and a gate electrically coupled to the SCR enable switch so as to receive the signal from the delay/LIP enable circuit. The SCR may be configured to conduct a forward conduction current between the high voltage line and the low voltage line when the signal from the delay/LIP enable circuit exceeds a gate threshold value. The signal received from the delay/LIP enable circuit may comprise a gate voltage and current that exceeds the gate threshold value which may safely and sufficiently trigger the SCR.

The timer-based fault protection circuit 100, 300 and method 500 described above may allow for the switchable low impedance path 130, 330 to conduct a forward conduction current between the high voltage line 102, 302 and the low voltage line 104, 304 after a time-period or delay. The time-period may be from a time at which an over-voltage condition is applied to the high voltage line. The time-period or delay may be configurable by, for example, selecting capacitance values of the RC network 123, 323 described above. The switchable low impedance path 130, 330 may conduct the forward conduction current at a voltage value that is less than the breakdown voltage of the TVS diode 140, 340 electrically coupled to the high voltage line 102, 302 and the low voltage line.

As a result, the TVS diode 140, 340 is not subjected to the current for longer than the time-period or delay. The time-period or delay may be selected to ensure that the over-voltage condition does not induce a current through the TVS diode 140, 340 for longer than, for example, a rated time-period of the TVS diode 140, 340 for a voltage of the over-voltage condition. In addition, the timer-based fault protection circuit 100, 300 automatically returns, after the over-voltage condition ends, to a normal operation condition in which the switchable low impedance path 130, 330 does not conduct a current. This can ensure that the only return path from the high voltage line to the low voltage line is via the intrinsically safe load ISL.

Accordingly, the timer-based fault protection circuit 100, 300 and method 500 can ensure suitable protection against a variety of over-voltage conditions while also minimizing the amount of intervention required and resistive losses when providing such protection. The timer-based fault protection circuit 100, 300 and method 500 can also minimize the power dissipation required while the over-voltage condition is present. The size of the required form factor and the costs may therefore be less than, for example, that of a high wattage Zener diode only circuit.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to timer-based fault protection circuits and not just to the embodiments described above and shown in the accompanying figures. Accordingly, the scope of the embodiments described above should be determined from the following claims.

We claim:

1. A timer-based fault protection circuit (100, 300), comprising:
a high voltage line (102, 302) configured to electrically couple to a first terminal of an intrinsically safe load (ISL);
a low voltage line (104, 304) configured to electrically couple to a second terminal of the intrinsically safe load (ISL);
a voltage limiter (110, 310) and a delay/LIP enable circuit (120, 320) electrically coupled to the high voltage line (102, 302) and the low voltage line (104, 304) electrically parallel to the intrinsically safe load (ISL); and
a switchable low impedance path (130, 330) electrically coupled to the high voltage line (102, 302) and the low voltage line (104, 304) in a shunt configuration relative to the intrinsically safe load (ISL);
wherein:
the voltage limiter (110, 310) is communicatively coupled to the delay/LIP enable circuit (120, 320) and configured to provide a signal to the delay/LIP enable circuit (120, 320); and
the delay/LIP enable circuit (120, 320) is communicatively coupled to the switchable low impedance path (130. 330) and configured to provide a signal to the switchable low impedance path (130, 330).

2. The timer-based fault protection circuit (100, 300) of claim 1, further comprising a transient voltage suppression diode (140, 340) having a first terminal electrically coupled to the high voltage line (102, 302) and a second terminal electrically coupled to the low voltage line (104, 304), wherein the transient voltage suppression diode (140, 340) is configured to conduct a current between the high voltage line (102, 302) and the low voltage line (104, 304) when a voltage of the high voltage line (102, 302) is greater than a breakdown voltage of the transient voltage suppression diode (140, 340).

3. The timer-based fault protection circuit (100, 300) of claim 2, wherein, when the signal is received from the delay/LIP enable circuit (120, 320), the switchable low impedance path (130, 330) is configured to conduct a forward conduction current between the high voltage line (102, 302) and the low voltage line (104, 304) at a voltage that is less than a breakdown voltage of the transient voltage suppression diode (140, 340).

4. The timer-based fault protection circuit (100, 300) of claim 1, wherein the voltage limiter (110, 310) is configured to:
sense a voltage of the high voltage line (102, 302) relative to a voltage of the low voltage line (104, 304); and
provide the signal to the delay/LIP enable circuit (120, 320) when the voltage of the high voltage line (102, 302) relative to the voltage of the low voltage line (104, 304) is greater than an over-voltage threshold value.

5. The timer-based fault protection circuit (100, 300) of claim 4, wherein the voltage limiter (110, 310) comprises:
a voltage divider (112, 312) having a first terminal electrically coupled to the high voltage line (102, 302) and a second terminal electrically coupled to the low voltage line (104, 304) and configured to provide a reference voltage (V1) based on the voltage of the high voltage line (102, 302) relative to the voltage of the low voltage line (104, 304); and
a first voltage adjustable shunt regulator (114, 314) having a first terminal electrically coupled to the high voltage line (102, 302), a second terminal electrically coupled to the low voltage line (104, 304), and a voltage reference terminal (V_{REF}) configured to receive the reference voltage (V1), wherein the first voltage adjustable shunt regulator (114, 314) is configured to conduct a current based on the reference voltage (V1).

6. The timer-based fault protection circuit (100) of claim 1, wherein the delay/LIP enable circuit (120, 320) is configured to:
receive the signal from the voltage limiter (110, 310);
initiate a timer function of the delay/LIP enable circuit (120, 320) when the signal is received from the voltage limiter (110, 310); and
provide the signal to the switchable low impedance path (130, 330) when the timer function reaches a delay threshold value.

7. The timer-based fault protection circuit (100, 300) of claim 6, wherein the delay/LIP enable circuit (120, 320) comprises:
an RC network (123, 323) configured to receive the signal from the voltage limiter (110, 310) and charge one or more capacitors in the RC network (123, 323) to a voltage using the signal from the voltage limiter (110, 310);
a second voltage adjustable shunt regulator (124, 324) electrically coupled to the RC network (123, 323) and configured to receive the voltage of the one or more capacitors in the RC network (123, 323) and conduct a current based on the voltage of the one or more capacitors of the RC network (123, 323); and
an SCR enable switch (126, 323) electrically coupled to the second voltage adjustable shunt regulator (124, 324), the SCR enable switch (126, 326) being configured to provide the signal to the switchable low impedance path (130, 330) when the second voltage adjustable shunt regulator (124, 324) conducts the current.

8. The timer-based fault protection circuit (100, 300) of claim 7, wherein the second voltage adjustable shunt regulator (124, 324) comprises:
a first terminal electrically coupled to the high voltage line (102, 302) and a base terminal of the SCR enable switch (126, 326);
a second terminal electrically coupled to the low voltage line (104, 304); and
a reference voltage terminal (VREF) configured to receive the voltage of the one or more capacitors of the RC network (123, 323);
wherein the second voltage adjustable shunt regulator (124, 324) is configured to conduct the current from the high voltage line (102, 302) to the low voltage line (104, 304) in proportion to the voltage of the one or more capacitors of the RC network (123, 323).

9. The timer-based fault protection circuit (100, 300) of claim 1, wherein the switchable low impedance path (130, 330) comprises:
an SCR (130D, 330D) having a first terminal electrically coupled to the high voltage line (102, 302), a second terminal electrically coupled to the low voltage line (104, 304), and a gate electrically coupled to the SCR enable switch (126, 326) so as to receive the signal from the delay/LIP enable circuit (120, 320);
wherein the SCR (130D, 330D) is configured to conduct a forward conduction current between the high voltage line (102, 302) and the low voltage line (104, 304) when the signal from the delay/LIP enable circuit (120, 320) exceeds a gate threshold value.

10. The timer-based fault protection circuit (100, 300) of claim 9, wherein the signal received from the delay/LIP enable circuit (120, 320) comprises a voltage value of the high voltage line (102, 302) that exceeds the gate threshold value.

11. The timer-based fault protection circuit (100, 300) of claim 9, wherein the SCR (130D, 330D) is configured to conduct the forward conduction current while a forward conduction current is greater than a holding current of the SCR (130D, 330D).

12. A method of forming a timer-based fault protection circuit, the method comprising:
configuring a high voltage line to electrically couple to a first terminal of an intrinsically safe load;
configuring a low voltage line to electrically couple to a second terminal of the intrinsically safe load;
electrically coupling a voltage limiter and a delay/LIP enable circuit to the high voltage line and the low voltage line electrically parallel to the intrinsically safe load;
electrically coupling a switchable low impedance path to the high voltage line and the low voltage line in a shunt configuration relative to the intrinsically safe load;
communicatively coupling the voltage limiter to the delay/LIP enable circuit and configured to provide a signal to the delay/LIP enable circuit;
communicatively coupling the delay/LIP enable circuit to the switchable low impedance path; and
configuring the delay/LIP enable circuit to provide a signal to the switchable low impedance path.

13. The method of claim 12, further comprising electrically coupling a first terminal of a transient voltage suppression diode to the high voltage line and a second terminal to the low voltage line, wherein the transient voltage suppression diode is configured to conduct a current between the high voltage line and the low voltage line when a voltage of the high voltage line is greater than a breakdown voltage of the transient voltage suppression diode.

14. The method of claim 13, wherein, when the signal is received from the delay/LIP enable circuit, configuring the switchable low impedance path to conduct a forward conduction current between the high voltage line and the low voltage line at a voltage that is less than a breakdown voltage of the transient voltage suppression diode.

15. The method of claim 12, further comprising configuring the voltage limiter to:
sense a voltage of the high voltage line relative to a voltage of the low voltage line; and
provide the signal to the delay/LIP enable circuit when the voltage of the high voltage line relative to the voltage of the low voltage line is greater than an over-voltage threshold value.

16. The method of claim 15, wherein electrically coupling the voltage limiter to the high voltage line and the low voltage line comprises:
electrically coupling a first terminal of a voltage divider to the high voltage line and a second terminal of the voltage divider to the low voltage line and configuring the voltage divider to provide a reference voltage based on the voltage of the high voltage line relative to the voltage of the low voltage line; and
electrically coupling a first terminal of a first voltage adjustable shunt regulator to the high voltage line and a second terminal of the first voltage adjustable shunt regulator to the low voltage line, receiving with a voltage reference terminal of the first voltage adjustable shunt regulator the reference voltage, and configuring the first voltage adjustable shunt regulator to conduct a current based on the reference voltage.

17. The method of claim 12, further comprising configuring the delay/LIP enable circuit to:
receive the signal from the voltage limiter;
initiate a timer function of the delay/LIP enable circuit when the signal is received from the voltage limiter; and
provide the signal to the switchable low impedance path when the timer function reaches a delay threshold value.

18. The method of claim 17, wherein the delay/LIP enable circuit comprises:
an RC network configured to receive the signal from the voltage limiter and charge one or more capacitors in the RC network to a voltage using the signal from the voltage limiter;
a second voltage adjustable shunt regulator electrically coupled to the RC network and configured to receive the voltage of the one or more capacitors in the RC network and conduct a current based on the voltage of the one or more capacitors of the RC network; and
an SCR enable switch electrically coupled to the second voltage adjustable shunt regulator, the SCR enable switch being configured to provide the signal to the switchable low impedance path when the second voltage adjustable shunt regulator conducts the current.

19. The method of claim 18, wherein the second voltage adjustable shunt regulator comprises:
a first terminal electrically coupled to the high voltage line and a base terminal of the SCR enable switch;
a second terminal electrically coupled to the low voltage line; and
a reference voltage terminal configured to receive the voltage of the one or more capacitors of the RC network;
wherein the second voltage adjustable shunt regulator is configured to conduct the current from the high voltage line to the low voltage line in proportion to the voltage of the one or more capacitors of the RC network.

20. The method of claim 12, wherein the switchable low impedance path comprises:
an SCR having a first terminal electrically coupled to the high voltage line, a second terminal electrically coupled to the low voltage line, and a gate electrically coupled to the SCR enable switch so as to receive the signal from the delay/LIP enable circuit;
wherein the SCR is configured to conduct a forward conduction current between the high voltage line and the low voltage line when the signal from the delay/LIP enable circuit exceeds a gate threshold value.

21. The method of claim 20, wherein the signal received from the delay/LIP enable circuit comprises a voltage value of the high voltage line that exceeds the gate threshold value.

22. The method of claim 20, wherein the SCR is configured to conduct the forward conduction current while the forward conduction current is greater than a holding current of the SCR.
